(19) United States
(12) Patent Application Publication
(10) Pub. No.: US 2025/0086861 A1
(43) Pub. Date: Mar. 13, 2025

(54) IMAGE PROCESSING APPARATUS

(71) Applicant: NEC Solution Innovators, Ldt., Koto-ku, Tokyo (JP)

(72) Inventor: Kazuhide UMEDA, Tokyo (JP)

(73) Assignee: NEC Solution Innovators, Ldt., Koto-ku, Tokyo (JP)

(21) Appl. No.: 18/728,435

(22) PCT Filed: Jan. 12, 2023
(86) PCT No.: PCT/JP2023/000652

§ 371 Date: Jul. 11, 2024

(30) Foreign Application Priority Data
Jan. 27, 2022 (JP) 2022-011104

(51) Int. Cl. G06T 11/60; G06V 40/10

(52) U.S. Cl. CPC G06T 11/60; G06V 40/103

(57) ABSTRACT

An image processing apparatus includes: an acquiring unit that acquires image data; and a processing unit that performs, on a range determined in accordance with a predetermined condition in a region corresponding to a person within the image data acquired by the acquiring unit, image processing for hiding information within the range.

### TECHNICAL FIELD

The present invention relates to an image processing apparatus, an image processing method, and a recording medium.

### BACKGROUND ART

There is a case of performing predetermined image processing such as pixelation or masking on a person appearing within image data.

Literature in which such image processing is described is, for example, Patent Literature 1. Patent Literature 1 describes an image processing apparatus that has a control unit and an image processing unit. According to Patent Literature 1, the control unit specifies a non-processing target subject as a non-processing target that will not be subjected to predetermined image processing from among a plurality of subjects based on the positional relation between a plurality of subject regions corresponding to a plurality of subjects, respectively, within a frame constituting a moving image and a specific region in the frame. The image processing unit then performs the predetermined image processing on a processing target region corresponding to a processing target subject other than the non-processing target subject among the plurality of subjects. Patent Literature 1 also discloses that the subject region is a face region corresponding to the subject.

### CITATION LIST

### Patent Literature

Patent Literature 1: Japanese Unexamined Patent Application Publication No. JP-A 2021-033573

### SUMMARY OF INVENTION

### Technical Problem

Under some conditions, such as the application and content of image data, it may be desired to perform image processing on a region other than a face region. However, in the case of the technique described in Patent Literature 1, it is the only issue whether or not to perform image processing on a face region. Therefore, the problem as described above cannot be addressed. Thus, there is a problem that it may be impossible to perform precise image processing appropriate according to a condition.

Accordingly, an object of the present invention is to provide an image processing apparatus, an image processing method, and a recording medium which solve the problem that it may be impossible to perform precise image processing according to a condition.

### Solution to Problem

In order to achieve the object, an image processing apparatus as an aspect of the present disclosure includes: an acquiring unit that acquires image data; and a processing unit that performs image processing on a range determined in accordance with a predetermined condition in a region corresponding to a person within the image data acquired by the acquiring unit, the image processing being for hiding information within the range.

Further, an image processing method as another aspect of the present disclosure is executed by an information processing apparatus, and includes: acquiring image data; and performing image processing on a range determined in accordance with a predetermined condition in a region corresponding to a person within the acquired image data, the image processing being for hiding information within the range.

Further, a recording medium as another aspect of the present disclosure is a non-transitory computer-readable recording medium with a program recorded thereon, and the program includes instructions for causing an information processing apparatus to realize processes to: acquire image data; and perform image processing on a range determined in accordance with a predetermined condition in a region corresponding to a person within the acquired image data, the image processing being for hiding information within the range.

### Advantageous Effects of Invention

With the respective reconfigurations as described above, it becomes possible to perform precise image processing according to a condition.

### BRIEF DESCRIPTION OF DRAWINGS

FIG. 1 is a view for describing the overview of an image processing apparatus in a first example embodiment of the present disclosure.

FIG. 2 is a block diagram showing an example of the configuration of the image processing apparatus.

FIG. 3 is a view showing an example of information included by determination information.

FIG. 4 is a view showing an example of skeleton information.

FIG. 5 is a view showing an example of skeleton detection by a skeleton recognizing unit.

FIG. 6 is a view showing an example of processing by a processing unit.

FIG. 7 is a flowchart showing an example of the operation of the image processing apparatus.

FIG. 8 is a view showing an example of the hardware configuration of an image processing apparatus in a second example embodiment of the present disclosure.

FIG. 9 is a block diagram showing an example of the configuration of the image processing apparatus.

### DESCRIPTION OF EXAMPLE EMBODIMENTS

### First Example Embodiment

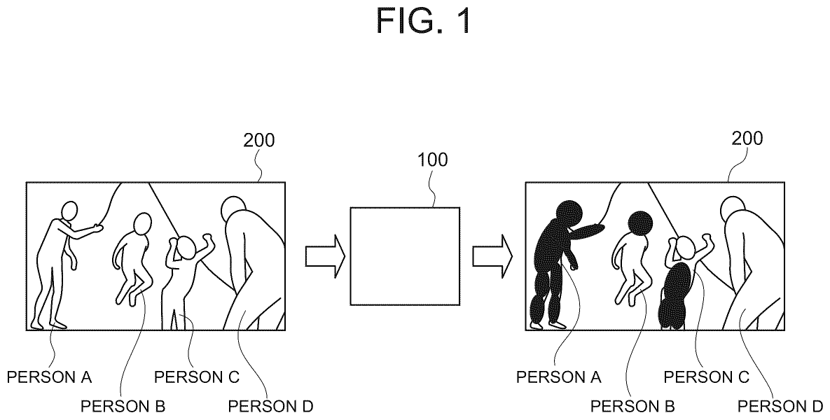

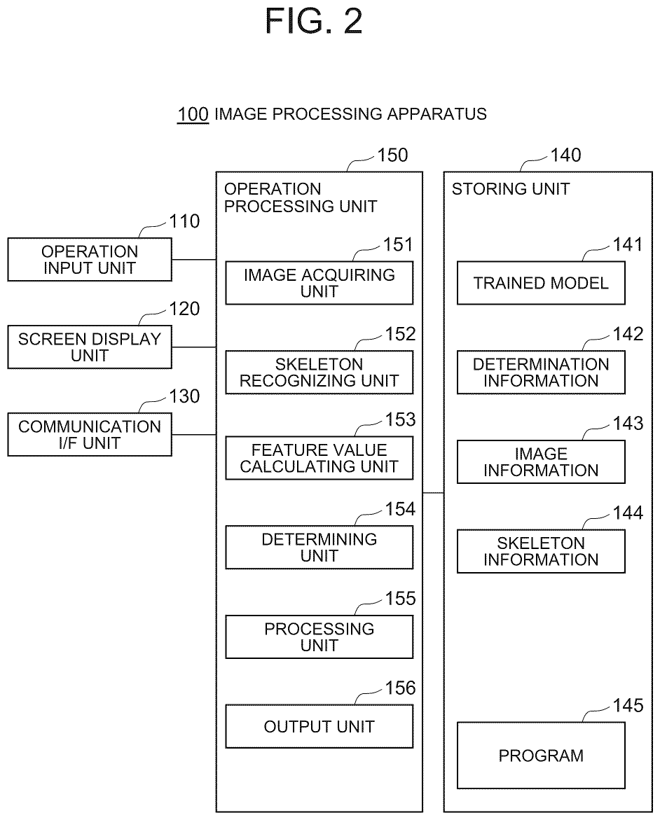

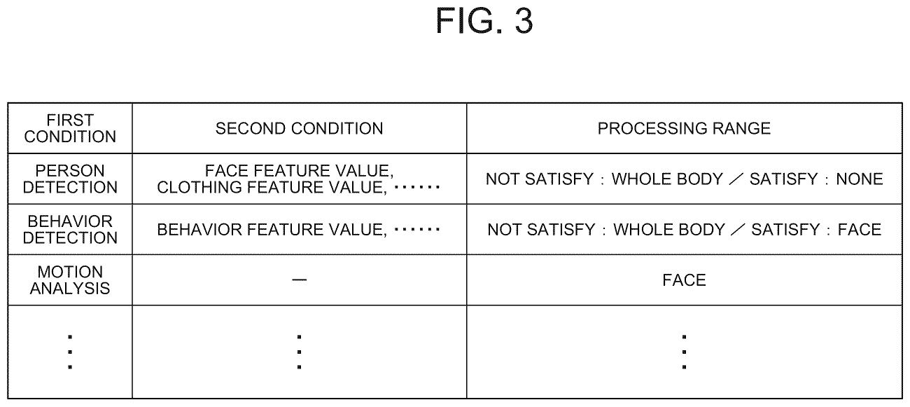

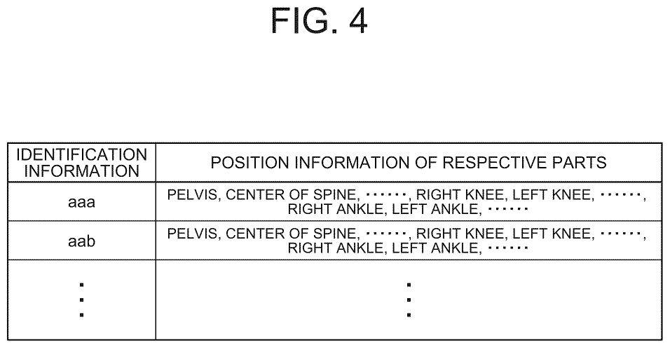

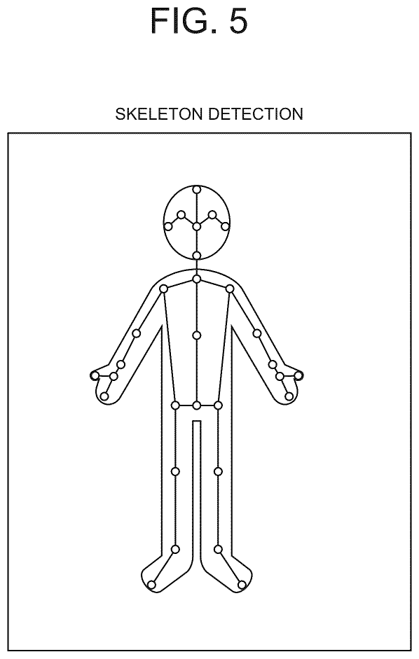

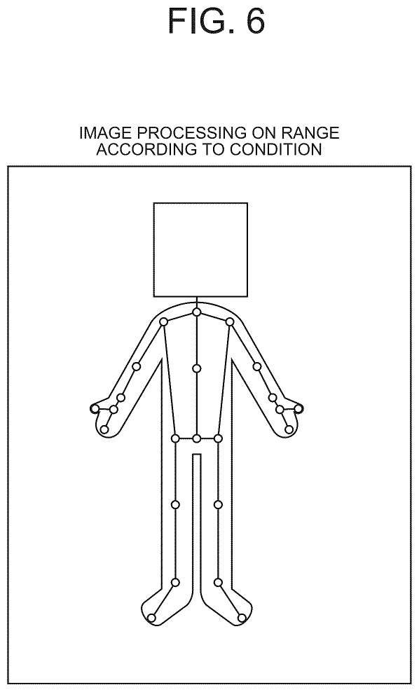

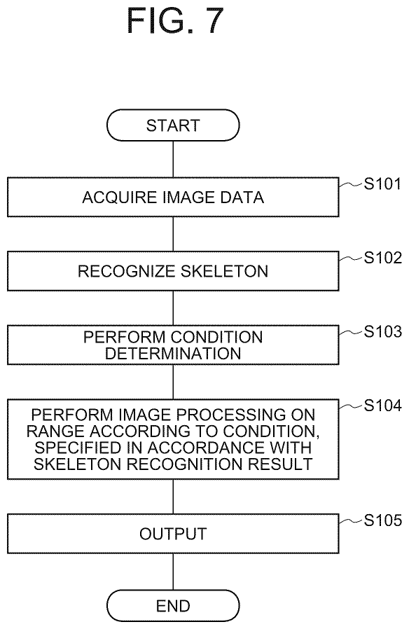

A first example embodiment of the present disclosure will be described with reference to FIGS. 1 to 7. FIG. 1 is a view for describing the overview of an image processing apparatus 100. FIG. 2 is a block diagram showing an example of the configuration of the image processing apparatus 100. FIG. 3 is a view showing an example of information included by determination information 142. FIG. 4 is a view showing an example of skeleton information 144. FIG. 5 is a view showing an example of skeleton detection by a skeleton recognizing unit 152. FIG. 6 is a view showing an example of processing by a processing unit 155. FIG. 7 is a flowchart showing an example of the operation of the image processing apparatus 100.

In the first example embodiment of the present disclosure, the image processing apparatus 100 will be described that is an information processing apparatus performing image processing such as masking and pixelation on a predetermined region within acquired image data 200. As will be described later, upon acquiring the image data 200, the image processing apparatus 100 performs image processing on a predetermined range such as a part determined according to a predetermined condition in a region corresponding to a person appearing within the image data 200. For example, in the case illustrated by FIG. 1, the image processing apparatus 100 performs image processing on a range of “whole body” in a region corresponding to a person A within the image data 200. Moreover, the image processing apparatus 100 performs image processing on a range of “head” in a region corresponding to a person B within the image data 200, and performs image processing on a range of “body” in a region corresponding to a person C within the image data 200. On the other hand, the image processing apparatus 100 does not perform image processing on a region corresponding to a person D within the image data 200. For example, in this manner, the image processing apparatus 100 performs, for a region corresponding to each person within the image data 200, image processing such as masking on a range according to a condition based on the image data 200 or the person.

Further, the image processing apparatus 100 can be configured to determine a part or a range to be subjected to image processing for each region corresponding to a person appearing within the image data 200, in accordance with a condition such as the application of the image data 200 or a feature value calculated from the image data 200.

As will be described later, the image processing apparatus 100 in this example embodiment specifies a specified range to be subjected to image processing in a region corresponding to each person appearing in the image data 200 by using the result of skeleton detection by the skeleton recognizing unit 152. In other words, the image processing apparatus 100 performs image processing on a part or a range determined according to a condition such as the application of the image data 200 or a calculated feature value in a part or a range specified as a result of skeleton detection by the skeleton recognizing unit 152

FIG. 2 shows an example of the configuration of the image processing apparatus 100. Referring to FIG. 2, the image processing apparatus 100 has, as major components, an operation input unit 110, a screen display unit 120, a communication I/F unit 130, a storing unit 140, and an operation processing unit 150, for example.

FIG. 2 illustrates a case of realizing a function as the image processing apparatus 100 using a single information processing apparatus. However, the image processing apparatus 100 may be realized using a plurality of information processing apparatuses, for example, realized on the cloud. For example, the image processing apparatus 100 may be realized by a plurality of information processing apparatuses having part of the function illustrated by FIG. 2. Moreover, the image processing apparatus 100 may omit part of the configuration illustrated above, for example, may omit the operation input unit 110, or the image processing apparatus 100 may have a configuration other than illustrated above.

The operation input unit 110 is configured with operation input devices such as a keyboard and a mouse. The operation input unit 110 detects an operation by a person who operates the image processing apparatus 100, and outputs to the operation processing unit 150.

The screen display unit 120 is configured with a screen display device such as an LCD (Liquid Crystal Display). The screen display unit 120 can display on a screen a variety of information stored in the storing unit 140 in response to an instruction from the operation processing unit 150.

The communication I/F unit 130 is configured with a data communication circuit. The communication I/F unit 130 performs data communication with an external device such as an imaging device connected via a communication line.

The storing unit 140 is a storage device such as a hard disk or a memory. The storing unit 140 stores processing information and a program 145 that are necessary for a variety of processing by the operation processing unit 150. The program 145 is loaded and executed by the operation processing unit 150 to realize various processing units. The program 145 is previously loaded from an external device or a recording medium via a data input/output function such as the communication I/F unit 130 and stored in the storing unit 130. Major information stored in the storing unit 140 include, for example, a trained 141, determination information 142, image information 143, and skeleton information 144.

The trained model 141 is a trained model used when the skeleton recognizing unit 152 performs skeleton detection. For example, the trained model 141 is trained in advance so as to output skeletal coordinates and the like in response to input of the image data 200. As an example, the trained model 141 can be previously trained by an external device or the like performing machine learning using training data such as image data containing skeletal coordinates. For example, the trained model 141 is acquired from an external device or the like via the communication I/F unit 130 or the like and stored into the storing unit 140. The trained model 141 may be updated by a retraining process using additional training data.

The determination information 142 includes information for determining a range to be subjected to image processing. For example, the determination information 142 is previously acquired from an external device or the like via the communication I/F unit 130 or the like or previously input using the operation input unit 110 or the like, and stored into the storing unit 140.

FIG. 3 shows an example of information included by the determination information 142. Referring to FIG. 3, the determination information 142 can include a first condition, a second condition, a processing range, and so forth.

Here, the first condition indicates a condition that can be specified without using a feature value calculated based on the image data 200, such as the application of the image data 200. For example, the first condition can include applications such as person detection that is detection of a predetermined person through face recognition or the like using the image data 200, behavior detection that is detection of a predetermined behavior such as wandering or staying based on the time-series image data 200, and motion analysis indicating that the image data 200 will be used for analyzing a person's motion. The first condition may be a single one that is determined in advance, or may include a condition other than those illustrated above, such as analysis of a running form, analysis of a pitching form, or the like.

Further, the second condition indicates a more detailed condition corresponding to the first condition, such as various feature values calculated based on the image data 200. For example, the second condition can include various feature values corresponding to the first condition, such as a face feature value of a predetermined person, a clothing feature value according to the color, shape and the like of clothing such as a uniform, and a behavior feature value of a person calculated from the trajectory of action, time spent in a predetermined area and so forth that can be discriminated from the time-series image data 200. The second condition may be a so-called blacklist, whitelist or the like that is a collection of face feature values or the like of predetermined persons. The second condition may also indicate a feature value for a predetermined part that can be specified according to skeletal coordinates or the like. The second condition may include no condition, or may include a condition other than those exemplified above.

The processing range indicates a part or a range to be subjected to image processing according to the corresponding first condition and second condition. For example, the processing range can include information indicating a part or a range to be subjected to image processing in a region corresponding to a person, such as a whole body, a face, a body, or none. The processing range may indicate a more detailed part or range corresponding to a person, such as both arms, a lower body, or a right hand. In the case illustrated by FIG. 3, the processing range includes information indicating a range in a case where the second condition is satisfied and information indicating a range in a case where the second condition is not satisfied. However, the processing range may include more detailed information, such as information indicating a range for each second condition.

FIG. 3 shows an example of the determination information 142, and the information included by the determination information 142 is not limited to the case illustrated by FIG. 3. For example, the determination information 142 may include only one of the first condition and the second condition.

The image information 143 includes the image data 200 acquired by an external imaging device such as a camera. The image information 143 may include the time-series image data 200. For example, the image information 143 is previously acquired from an external device or the like via the communication I/F unit 130 or the like and stored into the storing unit 140.

As an example, in the image information 143, identification information for identifying the image data 200 and the image data 200 are associated. The image information 143 may include information other than those illustrated above, such as information indicating the date and time of acquisition of the image data 200 by the imaging device and information indicating the application of the image data 200.

As will be described later, the image information 143 may include the image data 200 before image processing and the image data 200 after image processing. In a case where the image information 143 includes the image data 200 after image processing, the image data 200 included by the image information 143 may be configured so that masking can be removed, or may be configured so that masking cannot be removed.

The skeleton information 144 includes information indicating the coordinates (skeletal coordinates) of respective parts of a person within the image data 200 recognized by the skeleton recognizing unit 152 through skeleton detection. For example, the skeleton information 144 includes, for each image data 200, information indicating the coordinates of respective parts corresponding to each person within the image data 200. For example, the skeleton information 144 is generated and updated as a result of a skeleton detection process performed by the skeleton recognizing unit 152.

FIG. 4 shows an example of the skeleton information 144. Referring to FIG. 4, in the skeleton information 144, for example, identification information and position information of respective parts are associated. Here, the identification information is information corresponding to a person within the image data 200. The position information of respective parts includes information indicating the skeleton information of respective parts within the image data 200, such as the position of the pelvis.

Parts included by the position information of respective parts correspond to those of the trained model 141. For example, pelvis, center of spine, . . . , right knee, left knee, . . . , right ankle, left ankle, . . . are shown in FIG. 4. The position information of respective parts can include, for example, about 30 parts such as right shoulder, . . . , left elbow, . . . (may also include a part other than those illustrated). The parts included by the position information of respective parts may be parts other than those illustrated in FIG. 4.

The operation processing unit 150 has an arithmetic logic unit such as a CPU (Central Processing Unit) and a peripheral circuit thereof. The operation processing unit 150 loads the program 145 from the storing unit 140 and executes the program 145 to realize various processing units by making the abovementioned hardware and the program 145 cooperate. Major processing units realized by the operation processing unit 150 are, for example, an image acquiring unit 151, a skeleton recognizing unit 152, a feature value calculating unit 153, a determining unit 154, a processing unit 155, an output unit 156, and so forth.

The image acquiring unit 151 acquires, from an external device such as the imaging device, the image data 200 acquired by the imaging device or the like via the communication I/F unit 130. The image acquiring unit 151 may acquire the time-series image data 200. Moreover, the image acquiring unit 151 stores the acquired image data 200 as the image information 143 into the storing unit 140.

Meanwhile, the image acquiring unit 151 may acquire information indicating the application or the like of the image data 200, other than the image data 200. The image acquiring unit 151 can store the information indicating the application or the like together with the image data 200 as the image information 143 into the storing unit 140.

The skeleton recognizing unit 152 recognizes the skeleton of a person within the image data 200 using the trained model 141. For example, by inputting the image data 200 into the trained model 141, the skeleton recognizing unit 152 acquires the coordinates of respective parts such as the upper part of spine, right shoulder, left shoulder, right elbow, left elbow, right wrist, left wrist, right hand, and left hand of each person within the image data 200 as illustrated in FIG. 5. Then, the skeleton recognizing unit 152 associates the acquired result with identification information for identifying the person, or the like, and stores as the skeleton information 144 into the storing unit 140.

Parts recognized by the skeleton recognizing unit 152 are those according to the trained model 141. Therefore, the skeleton recognizing unit 152 may recognize a part other than those illustrated above according to the trained model 141.

The feature value calculating unit 153 extracts a region corresponding to a person appearing within the image data 200, or the like, and calculates feature values such as face, clothing, and belongings. For example, the feature value calculating unit 153 calculates various feature values so as to be able to identify each person within the image data 200 in the same manner as the skeleton recognizing unit 152. The feature value calculating unit 153 may calculate the feature values using a known means.

For example, the feature value calculating unit 153 detects the face region of a person within the image data 200, extracts feature points such as eyes, nose, and mouth, and calculates a face feature value based on the extracted feature points. Moreover, the feature value calculating unit 153 can calculate feature values such as a clothing feature value and a belongings feature value based on color information, shape and the like of a predetermined part. The feature value calculating unit 153 may calculate a feature value for a predetermined part that can be specified by referring to the skeleton information 144. For example, the feature value calculating unit 153 may specify a predetermined part such as the right shoulder with reference to the skeleton information 144, and also calculate the clothing feature value and so forth based on color information and the like of the specified part.

The feature value calculating unit 153 may be configured to calculate only some of the feature values illustrated above, such as only the face feature value, or may be configured to calculate a plurality of feature values. Moreover, the feature value calculating unit 153 may be configured to calculate a feature value according to the application of the image data 200, for example. The feature value calculating unit 153 may calculate a feature value other than those illustrated above.

The determining unit 154 determines a part or a range to be subjected to image processing such as making based on a predetermined condition according to the application of the image data 200, the calculated feature value, and so forth. For example, the determining unit 154 can determine a part or a range according to the application of the image data 200 based on the first condition or the like. Also, the determining unit 154 can determine a part or a range according to the feature value or the like of each person calculated from the image data 200 based on the second condition or the like.

For example, the determining unit 154 refers to the determination information 142 and the image information 143. Then, the determining unit 154 determines a range according to the first condition in accordance with the application of the image data 200, and so forth. For example, in a case where the application of the image data 200 is “motion analysis”, the determining unit 154 can determine that a range to be subjected to image processing is a range of “head”.

Further, in such a case that the second condition is set, the determining unit 154 can determine a range according to the second condition by using a feature value calculated by the feature value calculating unit 153. For example, in a case where the application of the image data 200 is “behavior detection”, the determining unit 154 determines to perform image processing on a range of “face” in the region of a person whose calculated behavior feature value satisfies the second condition. On the other hand, the determining unit 154 determines to perform image processing on a range of “whole body” in the region of a person whose calculated behavior feature value does not satisfy the second condition. For example, as described above, the determining unit 154 can determine to perform image processing on a range according to the second condition or the like. In other words, the determining unit 154 can determine a range to be subjected to image processing for each person within the image data 200 based on the second condition and various feature values.

Meanwhile, the determining unit 154 may be configured to perform only one of the determination based on the first condition and the determination based on the second condition, or may be configured to, for example, determine a condition to be used for determination based on the determination information 142. Moreover, the determining unit 154 may determine to, for example, perform image processing on the same range for all the regions of persons who satisfy the second condition, or may determine to, for example, perform image processing on a range that varies for each predetermined second condition.

The processing unit 155 performs image processing such as masking on a range determined by the determining unit 154. Then, the processing unit 155 stores the result of the processing as the image information 143 or the like into the storing unit 140. Meanwhile, the processing unit 155 may perform processing for hiding information within a predetermined range, such as pixelation, instead of making.

For example, the processing unit 155 specifies a position or a range within the image data 200 corresponding to a part or a range determined by the determining unit 154 with reference to the coordinates of respective parts shown by the skeleton information 144. Then, the processing unit 155 performs image processing such as making on the specified position or range. Thus, the determining unit 154 performs image processing on the part or the range determined by the determining unit 154 using the result of recognition by the skeleton recognizing unit 152.

Meanwhile, after image processing such as masking, the processing unit 155 may store the result of the processing into the storing unit 140 or the like so that it can be restored, or may store the result of the processing into the storing unit 140 or the like so that it cannot be restored. For example, the processing unit 155 may store the image data 200 before masking and the image data 200 after masking separately into the storing unit 150, or may update information of the image information 143 with the image data 200 after masking. Moreover, the processing unit 155 may be configured to select whether to store the processing result so that it can be restored or store the processing result so that it cannot be restored in accordance with the application of the image data 200, or the like.

The output unit 156 outputs the image data 200 subjected to masking, and so forth. For example, the output unit 156 displays the image data 200 subjected to masking, and so forth, on the screen display unit 120, or transmits to an external device via the communication I/F unit 130. The output unit 156 may display or output information other than that illustrated above.

The above is an example of the configuration of the image processing apparatus 100. Subsequently, the operation of the image processing apparatus 100 will be described with reference to FIG. 7.

FIG. 7 is a flowchart showing an example of the operation of the image processing apparatus 100. Referring to FIG. 7, the image acquiring unit 151 acquires, from an external device such as an imaging device, the image data 200 acquired by the imaging device or the like via the communication I/F unit 130 (step S101).

The skeleton recognizing unit 152 recognizes the skeleton of a person within the image data 200 using the trained model 141 (step S102). For example, by inputting the image data 200 into the trained model 141, the skeleton recognizing unit 152 acquires the coordinates of respective parts such as the upper part of spine, right shoulder, left shoulder, right elbow, left elbow, right wrist, left wrist, right hand, and left hand of each person within the image data 200 as illustrated in FIG. 5.

The determining unit 154 determines a part or a range to be subjected to image processing such as masking based on a predetermined condition according to the application of the image data 200, the calculated feature value, and so forth (step S103). For example, the determining unit 154 determines a part or a range according to the application of the image data 200 based on the first condition or the like. Moreover, the determining unit 154 can determine a part or a range according to the feature value of each person calculated from the image data 200, based on the second condition or the like.

Meanwhile, processing by the determining unit 154 may be performed before processing at step S102, or may be performed with processing at step S102. Moreover, before or after processing at step S102 or step S103, the feature value calculating unit 153 may calculate various feature values.

The processing unit 155 performs image processing such as masking on the range determined by the determining unit 154 (step S104). In other words, the processing unit 155 performs image processing on the part or the range according to the condition specified using the result of skeleton recognition, based on the result of determination by the determining unit 154.

The output unit 156 outputs the image data 200 subjected to masking, and so forth (step S105). For example, the output unit 156 displays the image data 200 subjected to masking, and so forth, on the screen display unit 120, or transmits to an external device via the communication I/F unit 130.

Thus, the image processing apparatus 100 has the processing unit 155. According to such a configuration, the processing unit 155 can perform image processing on a predetermined range such as a part determined according to a predetermined condition in a region corresponding to a person appearing within the image data 200. As a result, it is possible to precisely perform image processing on a range according to a condition.

For example, according to the present invention, it is possible to perform masking on a range other than that for the application or purpose, such as masking on a region other than a region corresponding to “body” used for behavior detection when acquiring the image data 200 for performing behavior detection or the like. As a result, for example, a part other than the minimum necessary part according to the application of the image data 200 and so forth is hidden, so that it is possible to more appropriately consider the privacy of a person within the image data 200, and so forth. Moreover, according to the present invention, for example, when analyzing the motion of a predetermined part or range of a person, it is possible to hide an unnecessary range. As a result, it is possible to perform analysis with unnecessary information on the unnecessary part eliminated.

Further, the image processing apparatus 100 has the determining unit 154. According to such a configuration, the processing part 155 can perform image processing on a part or a range according to the result of determination by the determining unit 154. As a result, it is possible to perform image processing on a range corresponding to a condition more appropriately.

### Second Example Embodiment

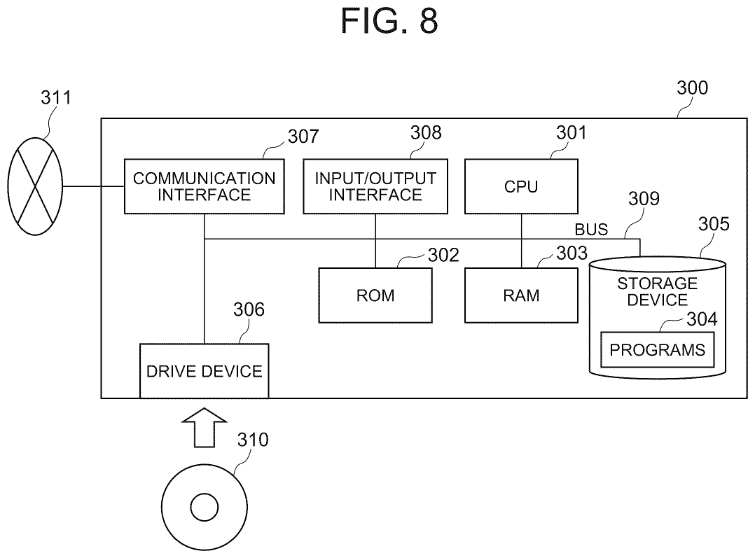

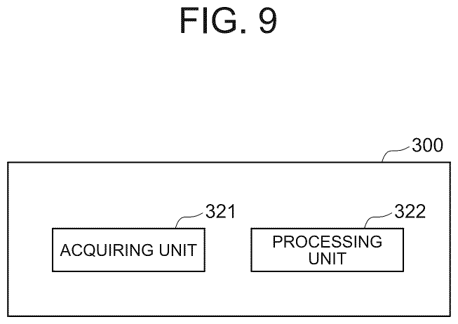

Next, with reference to FIGS. 8 and 9, a second example embodiment of the present disclosure will be described. In the second example embodiment of the present disclosure, the overview of the configuration of an image processing apparatus 300 that is an information processing apparatus will be described.

FIG. 8 shows an example of the hardware configuration of the image processing apparatus 300. Referring to FIG. 8, as an example, the image processing apparatus 300 has a hardware configuration as shown below including:
a CPU (Central Processing Unit) 301 (arithmetic logic unit),
a ROM (Read Only Memory) 302 (memory unit),
a RAM (Random Access Memory) 303 (memory unit),
programs 304 loaded to the RAM 303,
a storage device 305 storing the programs 304,
a drive device 306 that reads from and writes into a recording medium 310 outside the information processing apparatus,
a communication interface 307 that connects to a communication network 311 outside the information processing apparatus,
an input/output interface 308 that inputs and outputs data, and
a bus 309 that connects the respective components.

Further, the image processing apparatus 300 can realize functions as an acquiring unit 321 and a processing unit 322 shown in FIG. 9 by acquisition and execution of the programs 304 by the CPU 301. The programs 304 are, for example, previously stored in the storage device 305 and the ROM 302, and loaded to the RAM 303 or the like and executed by the CPU 301 as necessary. Meanwhile, the programs 304 may be provided to the CPU 301 via the communication network 311, or the programs 304 may be previously stored in the recording medium 310 and read and provided to the CPU 301 by the drive device 306.

FIG. 8 shows an example of the hardware configuration of the image processing apparatus 300. The hardware configuration of the image processing apparatus 300 is not limited to the abovementioned case. For example, the image processing apparatus 300 may be configured with part of the abovementioned configuration, for example, may be configured without the drive device 306.

The acquiring unit 321 acquires image data.

The processing unit 322 performs image processing for hiding information in a range, on a range determined according to a predetermined condition in a region corresponding to a person within the acquired image data.

Thus, the image processing apparatus 300 has the processing unit 322. According to such a configuration, the processing unit 322 can perform image processing for hiding information in a range, on a range determined according to a predetermined condition in a region corresponding to a person within the acquired image data. As a result, it is possible to perform precise image processing according to a condition.

The information processing apparatus such as the image processing apparatus 300 described above can be realized by installation of a predetermined program in the information processing apparatus. Specifically, a program as another aspect of the present invention is a program for causing an information processing apparatus to realize processes to: acquire image data; and perform image processing for hiding information in a range, on a range determined according to a predetermined condition in a region corresponding to a person within the acquired image.

Further, a determination method executed by the information processing apparatus described above is a method in which the information processing apparatus acquires image data and performs image processing for hiding information in a range, on a range determined according to a predetermined condition in a region corresponding to a person within the acquired image.

Inventions of a program (or recording medium), an image processing method and the like with the above configurations have the same actions and effects as the abovementioned case, so that it is possible to achieve the abovementioned object of the present invention.

### Supplementary Notes

The whole or part of the example embodiments disclosed above can be described as the following supplementary notes. Below, the overview of the image processing apparatus and so forth according to the present invention will be described. However, the present invention is not limited to the following configurations.

### (Supplementary Note 1)

An image processing apparatus, comprising:
an acquiring unit that acquires image data; and
a processing unit that performs image processing on a range determined in accordance with a predetermined condition in a region corresponding to a person within the image data acquired by the acquiring unit, the image processing being for hiding information within the range.

### (Supplementary Note 2)

The image processing apparatus according to Supplementary Note 1,
wherein the processing unit specifies the range to be subjected to the image processing using a result of skeleton recognition.

### (Supplementary Note 3)

The image processing apparatus according to Supplementary Note 1 or 2,
wherein the processing unit performs the image processing on a range determined in accordance with an application of the image data.

### (Supplementary Note 4)

The image processing apparatus according to any one of Supplementary Notes 1 to 3, comprising
a determining unit that determines the range to be subjected to the image processing in accordance with a predetermined condition,
wherein the processing unit performs the image processing on the range corresponding to a result of the determination by the determining unit.

### (Supplementary Note 5)

The image processing apparatus according to Supplementary Note 4,
wherein the determining unit determines the range to be subjected to the image processing based on an application of the image data.

### (Supplementary Note 6)

The image processing apparatus according to Supplementary Note 4 or 5, comprising
a calculating unit that calculates a predetermined feature value based on the image data,
wherein the determining unit determines the range to be subjected to the image processing based on the feature value calculated by the calculating unit.

### (Supplementary Note 7)

The image processing apparatus according to any one of Supplementary Notes 4 to 6,
wherein the determining unit determines the range to be subjected to the image processing for each person within the image data.

### (Supplementary Note 8)

An image processing method by an information processing apparatus, comprising:
acquiring image data; and
performing image processing on a range determined in accordance with a predetermined condition in a region corresponding to a person within the acquired image data, the image processing being for hiding information within the range.

### (Supplementary Note 9)

The image processing method according to Supplementary Note 8, comprising
in performing the image processing, specifying the range to be subjected to the image processing using a result of skeleton recognition, and performing the image processing on the specified range.

### (Supplementary Note 10)

A computer program comprising instructions for causing an information processing apparatus to realize processes to:
acquire image data; and
perform image processing on a range determined in accordance with a predetermined condition in a region corresponding to a person within the acquired image data, the image processing being for hiding information within the range.

The programs described in the respective example embodiments and supplementary notes above are stored in a storage device or recorded on a computer-readable recording medium. For example, the recording medium is a portable medium such as a flexible disk, an optical disk, a magneto-optical disk, and a semiconductor memory.

Although the present invention has been described above with reference to the above example embodiments, the present invention is not limited to the embodiments described above. The configuration and details of the present invention can be changed in various manners that can be understood by those skilled in the art within the scope of the present invention.

The present invention benefits from a priority claim based on patent application No. 2022-011104 filed in Japan on Jan. 27, 2022, the disclosure of which is incorporated herein in its entirety by reference.

### REFERENCE SIGNS LIST

100 image processing apparatus
110 operation input unit
120 screen display unit
130 communication I/F unit
140 storing unit
141 trained model
142 determination information
143 image information
144 skeleton information
145 program
150 operation processing unit
151 image acquiring unit
152 skeleton recognizing unit
153 feature value calculating unit
154 determining unit
155 processing unit
156 output unit
200 image data
300 image processing apparatus
301 CPU
302 ROM
303 RAM
304 programs
305 storage device
306 drive device
307 communication interface
308 input/output interface
309 bus
310 recording medium
311 communication network
321 acquiring unit
322 processing unit

What is claimed is:

1. An image processing apparatus, comprising:
at least one memory storing processing instructions; and
at least one processor configured to execute the instructions to:
acquire image data; and
perform image processing on a range determined in accordance with a predetermined condition in a region corresponding to a person within the acquired image data, the image processing being for hiding information within the range.

2. The image processing apparatus according to claim 1,
wherein the at least one processor is configured to execute the instructions to specify the range to be subjected to the image processing using a result of skeleton recognition.

3. The image processing apparatus according to claim 1,
wherein the at least one processor is configured to execute the instructions to perform the image processing on a range determined in accordance with an application of the image data.

4. The image processing apparatus according to claim 1,
wherein the at least one processor is configured to execute the instructions to:
determine the range to be subjected to the image processing in accordance with a predetermined condition; and
perform the image processing on the range corresponding to a result of the determination.

5. The image processing apparatus according to claim 4,
wherein the at least one processor is configured to execute the instructions to determine the range to be subjected to the image processing based on an application of the image data.

6. The image processing apparatus according to claim 4,
wherein the at least one processor is configured to execute the instructions to:
calculate a predetermined feature value based on the image data; and
determine the range to be subjected to the image processing based on the calculated feature value.

7. The image processing apparatus according to claim 4,
wherein the at least one processor is configured to execute the instructions to determine the range to be subjected to the image processing for each person within the image data.

8. An image processing method by an information processing apparatus, comprising:
acquiring image data; and
performing image processing on a range determined in accordance with a predetermined condition in a region corresponding to a person within the acquired image data, the image processing being for hiding information within the range.

9. The image processing method according to claim 8, comprising
in performing the image processing, specifying the range to be subjected to the image processing using a result of skeleton recognition, and performing the image processing on the specified range.

10. A non-transitory computer-readable recording medium with a program recorded thereon, the program comprising instructions for causing an information processing apparatus to realize processes to:
acquire image data; and
perform image processing on a range determined in accordance with a predetermined condition in a region corresponding to a person within the acquired image data, the image processing being for hiding information within the range.
